(19) United States
(12) Patent Application Publication
(10) Pub. No.: US 2001/0055387 A1
(43) Pub. Date: Dec. 27, 2001

(54) Encryption method, decryption method, cryptographic communication system and encryption device

(75) Inventors: Daisuke Suzuki, Toyono-gun (JP); Yasuyuki Murakami, Kyoto-shi (JP); Ryuichi Sakai, Kyoto-shi (JP); Masao Kasahara, Mino-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 09/771,021

(22) Filed: Jan. 25, 2001

(30) Foreign Application Priority Data
May 18, 2000 (JP) 2000-147047

(51) Int. Cl. H04L 9/30

(52) U.S. Cl. 380/30

(57) ABSTRACT

After an extended transformation of a plaintext, a reduced product-sum type encryption is carried out. The plaintext to be encrypted is divided thereby to obtain a plaintext vector. The plaintext vector is transformed by a predetermined function thereby to generate a transformation vector. Then, a ciphertext is generated by a product-sum operation between the components of a public key vector and the components of the plaintext vector and the transformation vector.

### BACKGROUND OF THE INVENTION

The present invention relates to an encryption method for encrypting a plaintext into a ciphertext, a decryption method for decrypting a ciphertext into a plaintext, a cryptographic communication system using these encryption method and decryption method, an encryption device for performing the encryption method, and a memory product/data signal embodied in carrier wave for recording/transferring an operation program of the encryption method.

In the modern society, called a highly information-oriented society, based on a computer network, important-business documents and image information are transmitted and communicated in a form of electronic information. Such electronic information can be easily copied, so that it tends to be difficult to discriminate its copy and original from each other, thus bringing about an important issue of data integrity. In particular, it is indispensable for establishment of a highly information oriented society to implement such a computer network that meets the factors of “sharing of computer resources,” “multi-accessing,” and “globalization,” which however includes various factors contradicting the problem of data integrity among the parties concerned. In an attempt to eliminate those contradictions, encrypting technologies which have been mainly used in the past military and diplomatic fields in the human history are attracting world attention as an effective method for that purpose.

A cipher communication is defined as exchanging information in such a manner that no one other than the parties concerned can understand the meaning of the information. In the field of cipher communication, encryption is defined as converting an original text (plaintext) that can be understood by anyone into a text (ciphertext) that cannot be understood by the third party and decryption is defined as restoring a ciphertext into a plaintext, and cryptosystem is defined as the overall processes covering both encryption and decryption. The encrypting and decrypting processes use secret information called an encryption key and a decryption key, respectively. Since the secret decryption key is necessary in decryption, only those knowing this decryption key can decrypt ciphertexts, thus maintaining data security.

The encryption scheme is roughly classified into two types: common-key cryptosystem and public-key cryptosystem. In a common-key cryptosystem, an encryption key and a decryption key are identical with each other, and a sender and a recipient perform cryptographic communications by possessing an identical common key. The sender encrypts a plaintext based on a secret common key and transmits the resultant ciphertext to the recipient, and then the recipient decrypts the ciphertext into the original plaintext by using this common key.

On the other hand, in a public-key cryptosystem, an encryption key and a decryption key are different from each other, and cryptographic communications are performed by encrypting a plaintext by the sender with the use of a publicized public key of the recipient and decrypting the resultant ciphertext by the recipient with the use of its own secret key. The public key is a key used for encryption and the secret key is a key used for decrypting the ciphertext transformed by the public key, and the ciphertext transformed by the public key can be decrypted only by the secret key.

Regarding the product-sum type cryptosystem using an operation on an integer ring, which is one of the public-key cryptosystems, new schemes and attacking methods have been proposed one after another. In particular, development of encryption/decryption techniques capable of performing high-speed decryption has been desired so as to process a large quantity of information in a short time. Then, the present inventors proposed an encryption method and a decryption method of the product-sum type cryptosystem, which enable high-speed decryption processing by using multi-adic numbers (Japanese Patent Application Laid-Open No. 2000-89668).

The process of the encryption method and the decryption method is performed as follows. A plaintext to be encrypted is divided into K parts, thereby obtaining a plaintext vector m=(m₁, m₂, . . . , m_{K}). Using a base product generated by bases bᵢ (1≦i≦K) and using random numbers vᵢ, the Bᵢ=vᵢ b₁ b₂ . . . bᵢ are defined. Using a prime number P, a random number w, and the Bᵢ, public keys cᵢ are calculated by cᵢ≡w Bᵢ (mod P). Here, the cᵢ are public keys while the bᵢ, vᵢ, P, and w are secret keys. Using the public keys cᵢ, a sender encrypts to obtain a ciphertext C=m₁ c₁+m₂ c₂+ . . . +m_{K} c_{K}. A recipient calculates an intermediate decrypted text M≡w⁻¹ C (mod P), thereby to decrypt by a sequential decryption algorithm. As such, the plaintext is expressed by multi-adic numbers, whereby a high-speed decryption can be performed.

Further, in order to prepare against low-density attacks using the LLL (Lenstra-Lenstra-Lovasz) algorithm, the present inventors have proposed an improvement of the above-mentioned encryption method (Japanese Patent Application No.11-173338(1999), referred to as “prior example” hereafter). This prior example is a reduced product-sum type cryptoscheme using error correcting codes, and includes the following alteration to the above-mentioned encryption method and decryption method.

1. Each divided plaintext to be encrypted is error-correction encoded, and used as the above-mentioned mᵢ.

2. An appropriate number of reduced bases are used for the bases {bᵢ} after a predetermined position, and normal bases are used otherwise. Here, the reduced bases and the normal bases satisfy mᵢ₋₁≧bᵢ and mᵢ₋₁<bᵢ, respectively.

3. The mᵢ indecryptable due to the influence of the reduced bases are decrypted using the capability of the error correcting codes.

In the prior example, it has been found that the mᵢ can be decrypted up to the position of the firstly appearing reduced base. Thus, despite that the firstly appearing reduced base is preferred to locate at a most possible ascending position, such an approach requires a large capability of error correction, thereby causing a problem of impracticality.

However, such a technique using reduced bases permits the density (input plaintext length/ciphertext length) to be increased by increasing the redundancy of the plaintext, and hence is an effective technique expected to be capable of increasing the resistance to attacks depending on the LLL algorithm. Thus, the present inventors have been researching further techniques of the reduced product-sum type cryptoscheme.

### BRIEF SUMMARY OF THE INVENTION

An object of the present invention is to provide: an encryption method and a decryption method capable of avoiding the problem in the prior example, having resistance to attacks depending on the LLL algorithm, and performing high-speed encryption and decryption; a cryptographic communication system and an encryption device using the same; and a memory product/data signal embodied in carrier wave for recording/transferring an operation program of the encryption method.

The prior example of the reduced product-sum type cryptoscheme using error correcting codes has a higher density than a conventional product-sum type cryptoscheme. Accordingly, it had been thought to be resistant to attacks depending on the LLL algorithm, but has been found to be decryptable. The decryptability results from that the reduced bases are located in the last part continuously. Thus, it is concluded that the reduced bases are to be located in a rather forward part in order to effectively increase the resistance to attacks depending on the LLL algorithm. However, in the prior example, the locating of reduced bases in a forward part requires a larger capability of error correction.

The proposal in the present invention is a reduced product-sum type cryptoscheme using an extended transformation of a plaintext. The present invention introduces a new technique of the extended transformation in place of the error correction coding. A predetermined transformation is applied on a plaintext vector to be encrypted, thereby generating a transformation vector for increasing the density, thereby performing an extended transformation. Then, a ciphertext is generated by the product-sum operation between the components of a public key vector and the components of the plaintext vector and the transformation vector. In the decryption of the ciphertext, reduced parts, to which an ordinary decryption method is inapplicable, are reproduced according to the above-mentioned predetermined transformation.

In the present invention, the technique of extended transformation of plaintext permits arranging of more reduced bases. Thus, with keeping the high speed in encryption and decryption, the density can be easily set to high to increase the resistance to attacks depending on the LLL algorithm. Further, a complicated encryption/decryption process like error correction coding is unnecessary, and hence encryption/decryption can be carried out easily.

The above and further objects and features of the present invention will more fully be apparent from the following detailed description with accompanying drawings.

### BRIEF DESCRIPTION OF THE SEVERAL VIEWS OF THE DRAWINGS

FIG. 1 is a schematic diagram showing a situation of communication between two entities in accordance with the present invention.

FIG. 2 is a diagram showing the configuration of an embodiment of a memory product of the present invention.

### DETAILED DESCRIPTION OF THE INVENTION

The embodiments of the present invention are described below in detail.

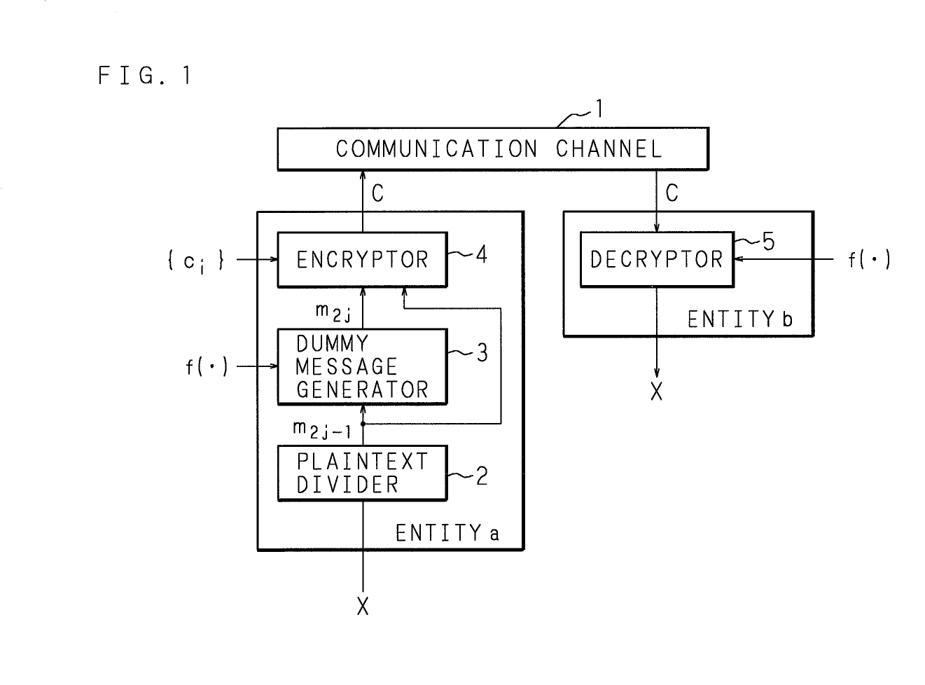

FIG. 1 is a schematic diagram showing a situation that an encryption method adopting the reduced product-sum type cryptoscheme in accordance with the present invention is used in the information communication between entities a, b. In the example of FIG. 1, one entity a encrypts a plaintext X into a ciphertext C, and sends the ciphertext C through a communication channel 1 to another entity b. The entity b then decrypts the ciphertext C into the original plaintext X.

The entity a on the sender side comprises: a plaintext divider 2 for dividing a plaintext X into a plurality of divided plaintexts thereby to obtain a plurality of messages m₁, m₃, . . . , m₂ⱼ₋₁, . . . ; a dummy message generator 3 for generating dummy messages m₂, m₄, . . . , m₂ⱼ, . . . from those odd-number-th messages m₁, m₃, . . . , m₂ⱼ₋₁, . . . in order to increase the density; and an encryptor 4 for generating a ciphertext C using these messages m₁, m₂, m₃, m₄, . . . , m₂ⱼ₋₁, m₂ⱼ, . . . , m_{K} and public keys c₁, c₂, . . . , c_{K}. On the other hand, the entity b on the recipient side comprises a decryptor 5 for calculating the messages mᵢ (1≦i≦K) according to a branching sequential decryption algorithm described later thereby to decrypt the sent ciphertext C into the original plaintext X.

The detail of the technique is described below.

[Preparation]

Secret keys and public keys are prepared as follows.

Secret keys: {bᵢ}, {vᵢ}, P, w

Public keys: {cᵢ}, f(·)

Let the size of each message mᵢ be e bits, then each message mᵢ satisfies the following (1).

mᵢ<2^{e} (1)

First, the plaintext X is divided, thereby obtaining the odd-number-th messages m₁, m₃, . . . , m₂ⱼ₋₁, . . . Next, using the message generating function f(·), the even-number-th messages m₂, m₄, . . . , m₂ⱼ, . . . are generated from the odd-number-th messages m₁, M₃, . . . , m₂ⱼ₋₁, . . . , thereby carrying out the extended transformation of the plaintext. Here, the even-number-th messages m₂, m₄, . . . , m₂ⱼ, . . . are dummy messages for increasing the density. The number of truly effective messages is expressed by the following (2) with the total number K of the messages.

$$⌊ \frac{K + 1}{2} ⌋ \qquad ( 2 )$$

Further, the bases bᵢ are assumed to be integers satisfying the following (3).

$${b}_{i} = \{ \begin{matrix}{2}^{3} + {δ}_{i} ( 1 ⪡ {δ}_{i} ⪡ {2}^{e} ) & ( i = 2 j ) \\ {2}^{{e}^{′}} + {δ}_{i}^{′} ( 1 ⪡ {δ}_{i}^{′} ⪡ {2}^{{e}^{′}} , {e}^{′} < e ) & ( i = 2 j - 1 )\end{matrix} \qquad ( 3 )$$

Multiplying a base product b₁ b₂ . . . bᵢ by a random number vᵢ, a base vector B=(B₁, B₂, . . . , B_{K}) is defined by the following (4).

Bᵢ=vᵢ b₁ b₂ . . . bᵢ (4)

Here, the random numbers vᵢ are set so that the components Bᵢ shown in the above-mentioned (4) are in the same order of magnitude with each other, while gcd(vᵢ, bᵢ₊₁)=1 is requested.

Using the random number w, the public keys cᵢ are obtained by the modulo transformation shown in the following (5).

cᵢ≡w Bᵢ (mod P) (5)

[Encryption]

A ciphertext C is obtained by a product-sum operation using the messages mᵢ and public keys cᵢ. Specifically, the ciphertext C is expressed by the following (6).

C=m₁c₁+m₂c₂+. . .+m_{K}c_{K} (6)

[Decryption]

Decryption processing is carried out as follows. An intermediate decrypted text M for the ciphertext C is calculated by the following (7).

M≡w⁻¹C(mod P) (7)

Then, the decryption into the messages mᵢ is performed according to a branching sequential decryption algorithm shown in the following (8).

$$[ \begin{matrix}Branching Sequential \\ Decryption Algorithm\end{matrix} ] \\ \begin{matrix}Step 1 \\ {M}_{1} = \frac{M}{{b}_{1}} \\ {m}_{1} ≡ {M}_{1} {v}_{1}^{- 1} ( mod {b}_{2} ) \\ Step i ( 2 ≦ i ≦ K - 1 ) \\ {M}_{i} = \frac{{M}_{i - 1} - {m}_{i - 1} {v}_{i - 1}}{{b}_{i}} \\ {m}_{i} = \{ \begin{matrix}{M}_{i} {v}_{i}^{- 1} ( mod {b}_{i + 1} ) & ( i = 2 j - 1 ) \\ f ( {m}_{i - 1} ) & ( i - 2 j )\end{matrix} \\ Step K \\ \begin{matrix} K \text{:} even number \\ no processing\end{matrix} \\ K \text{:} odd number \\ {M}_{K} = \frac{{M}_{K - 1} - {m}_{K - 1} {v}_{K - 1}}{{b}_{K}} \\ {m}_{K} = {M}_{K} {v}_{K}^{- 1}\end{matrix} \} \qquad ( 8 )$$

In this algorithm, the odd-number-th messages mᵢ are decrypted by a conventional technique, and the even-number-th messages mᵢ are decrypted by mᵢ=f(mᵢ₋₁) using the message generating function f(·).

The message generating function f(·) is discussed below. In order for an encryption method of the present invention to have a high resistance to attacks depending on the LLL algorithm, the f(·) shall not be linear. For example, in case of the identity transformation f(·), that is, in case that m₂ⱼ=m₂ⱼ₋₁, the ciphertext C can be rewritten as the following (9). Accordingly, by changing the number of the public keys into the number shown in the following (11) by the substitution shown in the following (10), and by applying a low-density attack, the plaintext can be obtained.

C=m₁c₁+m₂c₂+. . .+m_{K}c_{K}=m₁(c₁+c₂)+. . .+m_{K-1}(c_{K-1}+c_{K}) (9)

$$\begin{matrix}{c}_{i}^{′} = {c}_{2 i - 1} + {c}_{2 i} ( i ≦ ⌊ \frac{K + 1}{2} ⌋ ) & ( 10 ) \\ ⌊ \frac{K + 1}{2} ⌋ & ( 11 )\end{matrix}$$

However, a non-linearity of the f(·) is not necessarily sufficient for security. For example, in case that f(x)=a x+b (for example, when the f(·) inverts each bit of the messages mᵢ, a=−1 and b=2^{e}−1), the ciphertext C can be rewritten as the following (12), and the following (13) and (14) are obtained. Accordingly, by changing the number of the public keys into the number shown in the following (15), and by applying a similar low-density attack, the plaintext can be obtained.

C=m₁ (c₁+ac₂ )+. . . +b(c₂+c₄+. . . +c_{K}) (12)

$${C}^{′} = C - b {\sum }_{j = 1}^{⌊ ( K + 1 ) / 2 ⌋} {c}_{2 j} \qquad ( 13 )$$

cₜ′=c₂ₜ₊₁+ac₂ₜ₊₂ (14)

$$⌊ \frac{K + 1}{2} ⌋ \qquad ( 15 )$$

Examples of a safe message generating function f(·) are shown in the following (16) and (17). Here, the q is a prime number of e bits, and the u is an integer of e bits.

f(x)=x² modq (16)

f(x)=x\mathring{+}u (17)

(+: exclusive OR operation of each bit)

The message generating function f(·) may be made public by a reliable center or an entity. Since the bit operation in the f(·) is a non-linear transformation on an integer ring, when a logical operation such as shown in the above-mentioned (17) is introduced, the entity may make public the u alone corresponding to the f(·) with a parameter u which is made public by the center.

Next, the encryption rate and the density in an encryption method of the present invention is discussed below. Encryption rate r in a reduced product-sum type cryptography is defined by original plaintext length/ciphertext length. Density ρ is defined by plaintext length input into reduced product-sum type cryptography/ciphertext length. In the scheme of the present invention, the density ρ is defined by extended plaintext length/ciphertext length. Here, plaintext length L_{P}, extended plaintext length L_{E}, and ciphertext length L_{C} are defined by the following (18), (19), and (20), respectively. Then, encryption rate r and density ρ are expressed by the following (21) and (22), respectively.

$${L}_{P} = ⌊ \frac{K + 1}{2} ⌋ e \qquad ( 18 )$$

L_{E}=K e( 19)

$$\begin{matrix}{L}_{c} ≧ \{ \begin{matrix}e + {log}_{2} K + \frac{Ke}{2} + \frac{( K - 2 ) {e}^{′}}{2} & ( K \text{:} even number ) \\ e + {log}_{2} K + \frac{( K - 1 ) e}{2} + \frac{( K - 1 ) {e}^{′}}{2} & ( K \text{:} odd number )\end{matrix} & ( 20 ) \\ r ≦ \frac{{L}_{P}}{{L}_{C}} \approx \frac{e}{e + {e}^{′} + ( {log}_{2} K ) / K} & ( 21 ) \\ ρ = \frac{{L}_{E}}{{L}_{C}} & ( 22 )\end{matrix}$$

In the cryptoscheme of the present invention, when the value e′/e and hence the bit size e′ of the reduced bases becomes small, the encryption rate r increases as well as the density ρ. Accordingly, the contraction of reduced base size permits a high resistance to attacks depending on the LLL algorithm.

In an encryption method of the present invention, from the above-mentioned (20) and (22), the density ρ exceeds 1 even in the case of the minimum block number K=3. Thus, a high resistance is expected to attacks depending on the LLL algorithm. In this case, if e=64 and e′/e=α, the ciphertext length L_{C} satisfies the following condition (23). This provides a design of an epoch-making cryptoscheme having a far smaller block size than that of prior art public-key cryptography.

L_{C}=128+1.6+64α<194 (23)

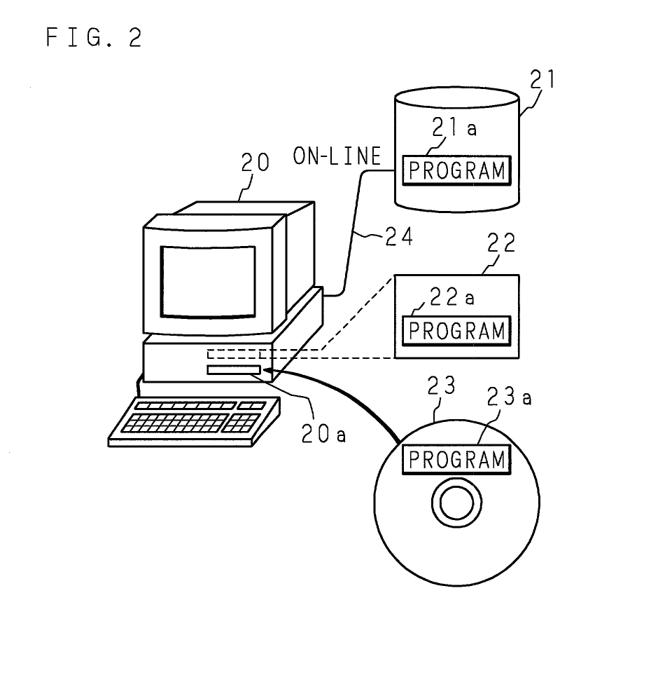

FIG. 2 is a diagram showing the configuration of an embodiment of a memory product in accordance with the present invention. The program illustrated here contains in the above mentioned example the processes of dividing the plaintext to be encrypted thereby to obtain the odd-number-th messages; generating the even-number-th messages from the odd-number-th messages using the message generating function f(·); and generating the product-sum type ciphertext using these messages and the public keys; or contains the process of decrypting the ciphertext into the original plaintext according to the above-mentioned branching sequential decryption algorithm, and further recorded in a memory product described below. A computer 20 is provided in an entity on the sender side or the recipient side.

In FIG. 2, a memory product 21 is composed of, for example, a server computer on the WWW (World Wide Web) installed apart from the installed location of the computer 20. In the memory product 21, a program 21a described above is recorded. The program 21a read out from the memory product 21 via a transfer medium 24 such as a communication line controls the computer 20 so as to generate a ciphertext from a plaintext or decrypt a ciphertext into a plaintext.

A memory product 22 provided in the interior of the computer 20 is composed of a disk drive, a ROM, or the like built in. In the memory product 22, a program 22a described above is recorded. The program 22a read out from the memory product 22 controls the computer 20 so as to generate a ciphertext from a plaintext or decrypt a ciphertext into a plaintext.

A memory product 23 used in the loaded state into a disk drive 20a provided in the computer 20 is composed of an magneto-optical disk, a CD-ROM, a flexible disk, or the like portable. In the memory product 23, a program 23a described above is recorded. The program 23a read out from the memory product 23 controls the computer 20 so as to generate a ciphertext from a plaintext or decrypt a ciphertext into a plaintext.

Although the description of the above-mentioned example has been made for a case of cryptographic communication system, an encryption method of the present invention is obviously applicable also in a case that a plaintext is encrypted into a ciphertext and that the generated ciphertext is merely recorded.

As described above, in the present invention, encryption is performed by making use of the extended transformation of plaintext, which increases the resistance to attacks depending on the LLL algorithm in comparison with the prior example. Further, in contrast to the prior example using error correction coding, a complicated encryption/decryption process is unnecessary. Thus, the process of calculation during encryption/decryption can be reduced, and hence, encryption/decryption can be carried out easily at a high speed. Furthermore, since the cryptographic block number can be made small, a small-scale hardware is sufficient to construct a cryptographic communication system. As a result, the present invention can contribute to a development for the industrial realization of the product-sum type cryptography.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalent of such metes and bounds thereof are therefore intended to me embraced by the claims.

1. An encryption method, comprising the steps of:
dividing a plaintext to be encrypted thereby to obtain a plaintext vector;
applying a predetermined transformation on the plaintext vector thereby to generate a transformation vector; and
generating a ciphertext by a product-sum operation between the components of a public key vector and the components of the plaintext vector and the transformation vector.

2. The encryption method of claim 1, wherein
the product-sum operation with the components of the public key vector is performed using alternately a component of the plaintext vector and a component of the transformation vector.

3. The encryption method of claim 1, wherein
the public key vector is obtained by a modulo transformation of a base-product vector.

4. The encryption method of claim 1, wherein:
the components of the plaintext vector and the transformation vector are expressed by (m₁, m₂, . . . , m_{K}); the components of the public key vector are obtained by a modulo transformation of the components Bᵢ of a base-product vector (B₁, B₂, . . . , B_{K}) (where Bᵢ=vᵢ b₁ b₂ . . . bᵢ, with random numbers vᵢ and bases bᵢ (1≦i≦K)); and as the bases bi, a normal base satisfying bᵢ>mᵢ₋₁ is used when the mᵢ₋₁ is a component of the plaintext vector while a reduced base satisfying bᵢ≦mᵢ₋₁ is used when the mᵢ₋₁ is a component of the transformation vector.

5. An encryption method, comprising the step of:
generating a product-sum type ciphertext using a first vector depending on a plaintext and a second vector having components obtained by a modulo transformation of base products; wherein
the first vector is composed of: a plaintext vector obtained by dividing a plaintext to be encrypted; and a transformation vector obtained by a transformation of the plaintext vector using a predetermined function; and wherein the base product is obtained by both normal bases satisfying bᵢ>mᵢ₋₁ (bᵢ is a base in the base product, mᵢ₋₁ is a component of the first vector, i is an element of a subset S of a universal set U={2,3, . . . , K}, and K is the number of components of the first and second vector) and reduced bases satisfying bⱼ≦mⱼ₋₁ (bⱼ is a base in the base product, mⱼ₋₁ is a component of the first vector, and j is an element of a complementary set of the subset S).

6. A decryption method for decrypting a ciphertext generated by the encryption method of claim 1, wherein the transformation vector is decrypted depending on decrypted components of the plaintext vector.

7. A decryption method for decrypting a ciphertext generated by the encryption method of claim 2, wherein the transformation vector is decrypted depending on decrypted components of the plaintext vector.

8. A decryption method for decrypting a ciphertext generated by the encryption method of claim 3, wherein the transformation vector is decrypted depending on decrypted components of the plaintext vector.

9. A decryption method for decrypting a ciphertext generated by the encryption method of claim 4, wherein the transformation vector is decrypted depending on decrypted components of the plaintext vector.

10. A decryption method for decrypting a ciphertext generated by the encryption method of claim 4, wherein a reduced-base part is decrypted depending on a decrypted normal-base part.

11. A decryption method for decrypting a ciphertext generated by the encryption method of claim 5, wherein a reduced-base part is decrypted depending on a decrypted normal-base part.

12. A cryptographic communication system for communicating information by a ciphertext between entities, comprising:
an encryptor for generating a ciphertext from a plaintext in accordance with the encryption method of claim 1;
a communication channel for transmitting the generated ciphertext from one entity to another entity; and
a decryptor for decrypting the transmitted ciphertext into a plaintext.

13. A cryptographic communication system for communicating information by a ciphertext between entities, comprising:
an encryptor for generating a ciphertext from a plaintext in accordance with the encryption method of claim 2;
a communication channel for transmitting the generated ciphertext from one entity to another entity; and
a decryptor for decrypting the transmitted ciphertext into a plaintext.

14. A cryptographic communication system for communicating information by a ciphertext between entities, comprising:
an encryptor for generating a ciphertext from a plaintext in accordance with the encryption method of claim 3;
a communication channel for transmitting the generated ciphertext from one entity to another entity; and
a decryptor for decrypting the transmitted ciphertext into a plaintext.

15. A cryptographic communication system for communicating information by a ciphertext between entities, comprising:
an encryptor for generating a ciphertext from a plaintext in accordance with the encryption method of claim 4;
a communication channel for transmitting the generated ciphertext from one entity to another entity; and
a decryptor for decrypting the transmitted ciphertext into a plaintext.

16. A cryptographic communication system for communicating information by a ciphertext between entities, comprising:
an encryptor for generating a ciphertext from a plaintext in accordance with the encryption method of claim 5;
a communication channel for transmitting the generated ciphertext from one entity to another entity; and
a decryptor for decrypting the transmitted ciphertext into a plaintext.

17. An encryption device for generating a product-sum type ciphertext from a plaintext, comprising a controller capable of performing the operations of:
(i) dividing a plaintext to be encrypted thereby to obtain a plaintext vector;
(ii) applying a predetermined transformation on the plaintext vector thereby to generate a transformation vector; and
(iii) generating a ciphertext by a product-sum operation between the components of a public key vector and the components of the plaintext vector and the transformation vector.

18. A computer memory product having computer readable program code means for causing a computer to generate a product-sum type ciphertext from a plaintext, said computer readable program code means comprising:
program code means for causing the computer to divide a plaintext to be encrypted thereby to obtain a plaintext vector;
program code means for causing the computer to apply a predetermined transformation on the plaintext vector thereby to generate a transformation vector; and
program code means for causing the computer to generate a ciphertext by a product-sum operation between the components of a public key vector and the components of the plaintext vector and the transformation vector.

19. A computer data signal embodied in a carrier wave for transmitting a program, the program being configured to cause a computer to generate a product-sum type ciphertext from a plaintext, comprising:
a code segment for causing the computer to divide a plaintext to be encrypted thereby to obtain a plaintext vector;
a code segment for causing the computer to apply a predetermined transformation on the plaintext vector thereby to generate a transformation vector; and
a code segment for causing the computer to generate a ciphertext by a product-sum operation between the components of a public key vector and the components of the plaintext vector and the transformation vector.
